(19) United States
(12) Patent Application Publication
(10) Pub. No.: US 2008/0313012 A1
(43) Pub. Date: Dec. 18, 2008

(54) Methods and apparatus for a digital music, video, and data player and recorder and business method of marketing music and video through a branded data storage device

(76) Inventors: Christian Braekman, Paris (FR); Andrew George, Beverly Hills, CA (US); Josh A. Lieber, Culver City, CA (US)

Correspondence Address: JAMES D. PETRUZZI, 4900 WOODWAY SUITE 745, HOUSTON, TX, 77056, US

(21) Appl. No.: 11/985,209

(22) Filed: Nov. 14, 2007

Related U.S. Application Data
(60) Provisional application No. 60/859,801, filed on Nov. 16, 2006.

(51) Int. Cl. G06Q 90/00; G06F 17/30; G06F 13/12

(52) U.S. Cl. 705/10; 710/63

(57) ABSTRACT

A digital storage device having a credit card sized carrier with memory and processor for processing digital data, an output on the card for converting and transmitting digital data for audio output, a set of touch sensitive controls on the planar surface of the card, a modifiable planar surface for placement of graphics, a USB connector for electrical access to the memory and processor for upload and downloading of the digital content. A method of marketing digital content using such a device by placing graphical information on the flat side of the carrier relating to the creator of the digital data content, and configuring the device with a video screen and shaped in any of a variety of configurations to match the marketing plan desired by the content provider. The device may also be used as a gift card with bar coding.

### CROSS REFERENCE TO RELATED APPLICATIONS

This application is based on provisional application Ser. No. 60/859,801, filed on Nov. 16, 2006, which is incorporated as if fully set forth herein

### STATEMENT REGARDING FEDERALLY SPONSORED RESEARCH OR DEVELOPMENT

Not Applicable

### DESCRIPTION OF ATTACHED APPENDIX

Not applicable

### BACKGROUND OF THE INVENTION

This invention relates generally to the field of music and more specifically to a method and apparatus for a digital music, video, and data player and recorder and a business method of marketing music and video through a branded data storage device.

There are a variety of prior art systems for recording and displaying digital music data. In recent times, music was etched into a vinyl disc known as an LP or Long Playing Record, which was replaced with cassette tapes and the CD. In the 90's with the advent of digitally available music from the Internet and other sources, single downloading of a song became prevalent and the rise of various music players using mp3 files and other digital formats were necessary to store and reply songs. As data storage became cheaper, such devices carried additional data such as videos and added content. In other cases, the CD has been sold with a DVD component that carries on one side the musical data and on the other videos, text and information typical of a CD ROM and the like. Currently, however there does not exist a simple device for storing digital data of music and associated videos for a single musical act in the form of an album, nor does the current player or CD have the ability to act as an efficient and cost effective advertising medium or marketing tool for retailers and musicians.

### BRIEF SUMMARY OF THE INVENTION

The primary advantage of the invention is to provide an improved music and video storage device, carrier and player.

Another advantage of the invention is to provide a digital data storage device that is not subject to piracy.

Another advantage of the invention is to provide a marketing and branding concept for music and video digital data.

Another advantage of the invention is to provide a vehicle for gift cards that operate as music players.

Another advantage of the invention is that it makes use of various microelectronics to deliver digital content in a convenient and innovative credit card sized package.

In accordance with a preferred embodiment of the invention, there is disclosed a digital storage device having a credit card sized carrier having a memory and processor for processing digital data, an output on the card for converting and transmitting the digital data for audio output, a set of touch sensitive controls on the planar surface of the card, a modifiable planar surface for placement of graphics, and a USB connector for electrical access to the memory and processor for upload and downloading of the digital content.

In accordance with another preferred embodiment of the invention, there is disclosed a method of marketing music comprising the steps of storing digital data content in memory in a credit card sized carrier, placing graphical information on the flat side of the carrier relating to the creator of the digital data content, permitting access to the digital data by a user through an interface, preventing the user from being capable of erasing the digital data from the memory.

In accordance with another preferred embodiment of the invention, there is disclosed a method for marketing music and video content comprising the steps of placing digital music and video content in data memory on a credit card sized handheld carrier capable of outputting the content in an audible and visual format, compiling music and video content for a particular artist for placement in the memory, branding the planar surface of the carrier with content related graphics, and locking access to the digital content to prevent erasure of the content.

Other advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a credit card sized music player device in accordance with a preferred embodiment of the invention.

FIG. 2 is a perspective view of a credit card sized digital player device with extended USB connector in accordance with a preferred embodiment of the invention

FIG. 3 is a perspective view of a guitar shaped version of the digital player in accordance with a preferred embodiment of the invention.

FIG. 4 is a plan view of a version of the digital player device with screen and extended USB connector in accordance with a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The term LP, refers to a specific type of gramophone record. LPs are usually made of polyvinyl chloride (PVC), and hence may be referred to as vinyl records or simply vinyl. They replaced the phonograph cylinder and were supplanted in popularity in the late 1980s by CDs. The instant invention seeks in part to replace the CD with a new multi-digital device for storing, displaying and transmitting data and the marketing associated therewith.

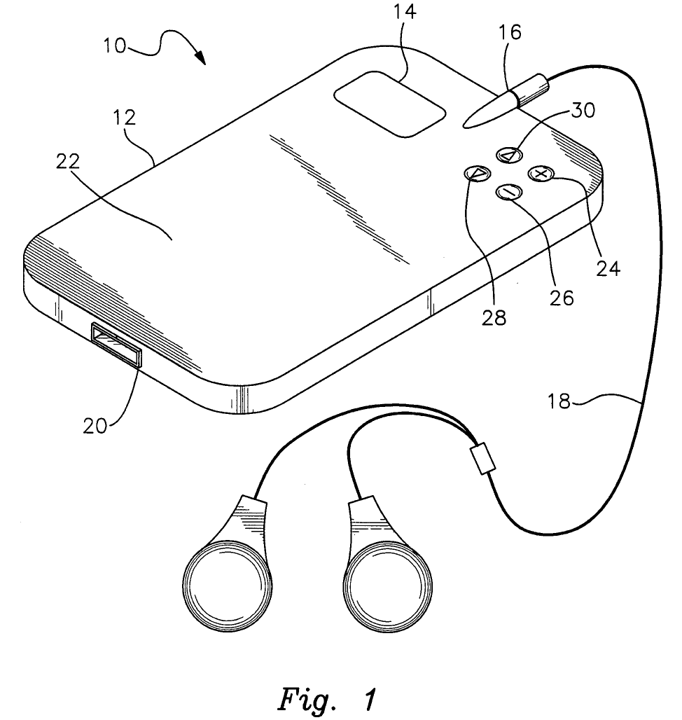

FIG. 1 shows a music player system 10 in accordance with a preferred embodiment of the present invention. Credit card sized body 12 has a memory and processor for processing digital data of any of a variety of formats. Body 12 is designed to conveniently fit in a wallet and has a planar surface 22 for placement of graphics which will be described in more detail below. Body 12 has an output jack 16 for insertion of an audio output device 18 which typically is a headphone or earbud configuration for listening to the audio output. Touch sensitive controls 24, 26, 28 and 30 permit the user to access the digital data according to a pre-determined relationship between the controls and the processor. As shown in FIG. 1, exemplary controls for up volume 24 and down volume 26 are shown. Further, up selector control 30 and down selector control 28 are provided to move from items displayed on screen 14. for example, the songs of a particular artist or album may be placed in the memory of the device and given sequential number identifiers that are displayed in screen 14. The user would then use controls 28 and 30 to move from number to number and play the desired selection. As is readily apparent, the controls can be of a variety of configurations and may also include additional feature control such as playlists, audio, video or other outputs desired of the device.

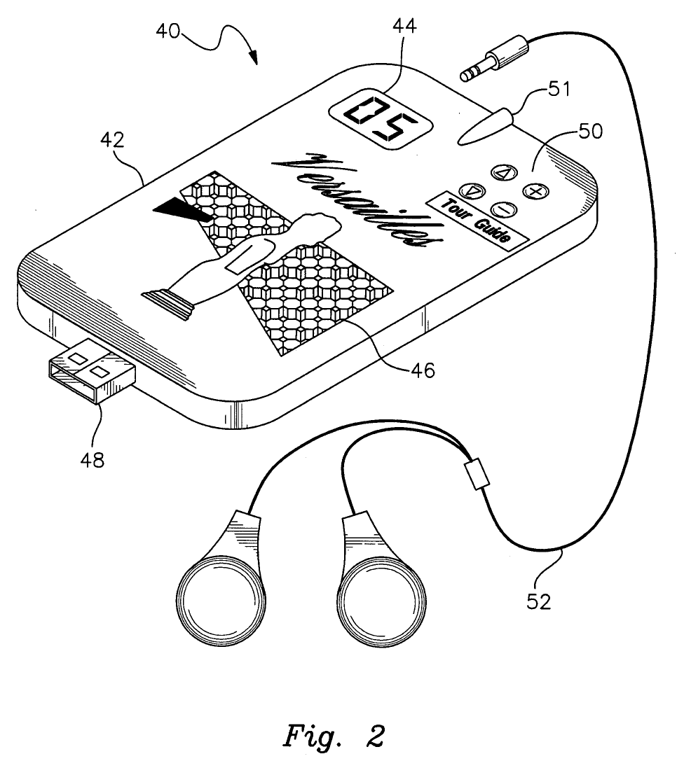

USB (Universal Serial Bus) is a plug-and-play interface between a computer and add-on devices (such as audio players, joysticks, keyboards, telephones, scanners, and printers). USB connector 20 is shown within body 12 to access the memory and processor and provide the ability to download digital content and perform other tasks common to USB. In this configuration, the USB connector is retractable as shown in FIG. 1, but may be deployed for use as shown in FIG. 2. Further, the system may be deployed without USB and configured in a thinner package approximately as thin as a credit card. In this configuration, the music is conveyed in a format much like an LP album or CD.

With no need for an additional player, hardware, software, nor downloading, the player is instantly functional in any situation. The digital player of the present invention re-creates the materialization of music and associates media with a physical and graphic support, restoring the material nature of the album. The digital player is not limited to audio but delivers video, text, graphics and interactivity and permits broad personalization.

The instant invention rehabilitates the music album as a complete and integrated artwork, mixing sound and graphics while adding a new digital dimension. It restores music ownership as a key motivation for purchase: increased perceived value, collectability, identification, gift giving, etc.

In a preferred embodiment, the player may have low power adaptable memory; 3.5 mm mini jack output; USB interface; retractable USB; 2-digit LCD display; membrane volume and select controls; On/Off lock switch; Rechargeable lithium battery; S/N Ratio 90 dB; and Audio frequency 20˜20 KHz.

FIG. 2 shows a credit card sized carrier 40 containing a microprocessor and memory for the storage of digital data and delivery of the data through audio jacks 51 video display 44 and download through USB connector 48, shown in the extended or deployed position. Due to the credit card configuration of carrier 40, graphics 46 may be placed on the planar surface of the carrier on either side to provide any of a variety of messages pertinent to the content of the carrier, or other message desired by the manufacturer. In FIG. 2, graphics 46 show a icon for the Versailles Museum and text denoting that the content of the carrier is a tour guide for the user. In other embodiments, the graphics may be advertising or other promotional content pertinent to the digital content such as an album cover, concert time and venue, sales event or any other content desired by the manufacturer or licensor of the content. FIG. 2 shows touch sensitive controls 50 with functionality as previously described.

In another embodiment, the device may also be a fixed data audio player with simple controls and no ability to download or erase the content of the memory. Encryption may be provided on the processor and memory that greatly reduces the ability to obtain access to the digital content by ordinary means available to the typical consumer.

The instant invention can be sold to a wide diversity of markets through a complete range of products, according to price, design and content. As an innovative medium, the instant invention represents a versatile support for all digital communication activities, primarily for the advertising and music industries. The instant invention may be sold online at a multilingual portal site or other convenient website or downloading location.

With strong identity, the portal site features a shop, a community forum (chatroom & message board), a collector's market and various special events related to the promotion of new and classic releases. Lifestyle music, or custom music compilation, is a growing trend and a new image tool for the retail, products, promotions and service industries. With its instantaneity feature, the instant invention is the perfect vehicle for a market that relies on impulse buying. In the retail store, the instant invention becomes an identity item that associates the purchaser with the retailer's specific universe.

There are at least several major target markets for the instant invention in lifestyle music: 1) major record labels' subsidiary labels, marketing their holding company's music catalogue into the brand and sponsoring markets; 2) the music label popularized by a well known coffee chain that distributes music CDs through the thousands of company-operated stores in the US; and 3) novelty distributors involved in the distribution of branded promotional products. Without production or music licensing expertise, these companies must team up with a label for product development.

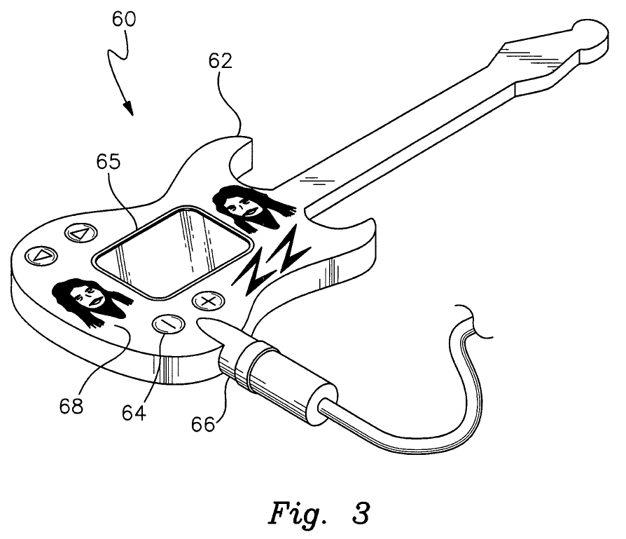

FIG. 3 shows yet another embodiment of the invention. Digital player system 60 is shown with thin body 62 in the shape of a guitar. As a promotional item, the body 62 has a memory and processor for the storage and delivery of digital content through the jack 66 and the visual display 65. Graphics 68 are provided on the surface of the body and may be content specific such as the artist whose work is contained in the memory, or other promotional graphics and information desired by the manufacturer. The body 62 is shown without USB connector, but in a desired configuration may easily have one included as discussed earlier.

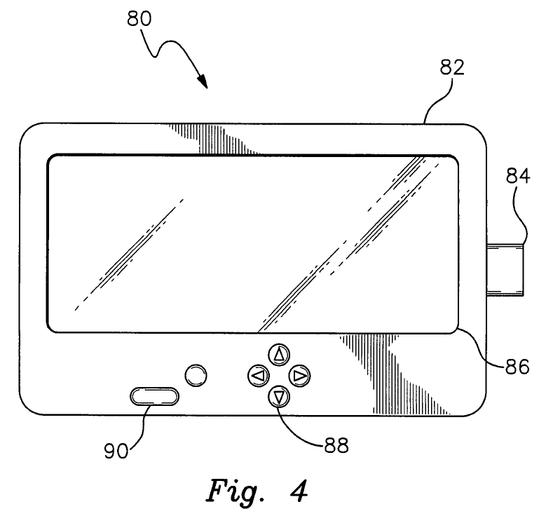

FIG. 4 shows yet another embodiment of the present invention. Digital player system 80 is shown with carrier 82 that houses the microprocessor and memory for storing and playing digital audio, video and other content. Screen 86 is configured to display text and graphics and video pertinent to the content and related thereto. Controls 88 work as previously disclosed. Additional control 90 may be added to the planar surface of the digital player for additional functionality. USB connector 84 shown in the deployed position, may be retractable or fold into the back side of the carrier for storage in a recessed pocket not shown.

An innovation of the present invention is a configuration described as the “sp-A” which stands for “self play Audio”. It is capable of setting the standard for future application denominations such as sp-V (self playing Video) or sp-G (self playing Game) etc. Naming and logotype conventions usually involve various industrial actors. Since sp-A is fully independent, it has the opportunity to impose a standard name on its own. The sp-A is a credit card size device that combines read-only audio data with a dedicated audio player. It may be developed around several core concepts.

Instantaneity—With no need for additional player nor digital manipulation, the sp-A is instantly functional in any situation; 2) Non-transferability—The music files in the sp-A are sealed in. The audio output is exclusively analogue. With no digital interface, data cannot be added nor removed. Digital piracy is simply impossible; and 3) Materialization of music—The sp-A associates audio with a physical and graphic support, restoring the material nature of the album.

Instantaneity means the ability to enjoy music as soon as acquired (desired), without the need for player or any additional device, hardware, software, network or technological knowledge. Instantaneity enables advertising and marketing to use or distribute music differently, right where their audience is. Instantaneity translates into accrued practicality and instant gratification for the user.

The digital player of the present invention is designed so that it cannot be pirated. It is secure by design. It does not rely on fragile encryption or on ethical behavior by consumers in order to protect intellectual property. For the music industry, non-transferability translates in better pre-release communication and better control over distribution.

Materialization refers to the physical nature of recorded music associated with its support. Materialization means rehabilitation of the music album as a complete and integrated artwork mixing sound and graphics. Materialization refers to the feeling of ownership associated with the possession of music: increased perception value, collectability, identification. Materialization restores music as a social tool: lending, borrowing, trading, giving.

The digital player of the present invention may have a variety of innovative features including: single chip design; low power 32 Mb Flash memory; specialized or standardized encoding; 1 analogue mini jack output; 2-digit LCD display; membrane volume and select controls; On/Off lock switch; 4 hours button cell RC2032 battery; S/N Ratio 90 dB; frequency 20-20 KHz; and no digital interface means no piracy

The digital player of the present invention can be sold to a wide diversity of markets through a complete range of products according to its price, design and content. As an innovative media, the concept disclosed herein represents a support for all audio communication activities involving the advertising and the music industries.

For its inception, the sp-A marketing may be useful in at least four identified markets:

1—as a promotional tool for music marketing;

2—as a support for album re-issues;

3—as a support for the brand music market; and

4—as a mass promotion giveaway

Re-materialization of album classics will invigorate sales by extending music distribution beyond the record store, particularly in the gift market, retail and mail order. With the materialization feature of the sp-A, music is a product again. As a collectible, a gift, a souvenir etc. . . . , the sp-A opens the perspective of multiple and diversified distribution.

Cross-marketing: Retail of the digital player of the present invention can be associated with an authorized internet download, allowing the consumer to own its music in both formats: proprietary to the instant digital player and mp3/wma. For the publisher, this cross-marketing concept (adaptable to all sp-A markets) carries substantial advantages:

Control over digital release dates and formats

DRM development

Customers' list consolidation

Download site publicity

The sp-A introduction follows a significant industry trend: the development of niche packaging as demonstrated by the recent surge in vinyl record sales by a public open to an alternative to the CD. Music catalogue rights are owned and commercialized by majors' subsidiaries These labels represent a potential prime target clients for the sp-A catalogue re-issue marketing

Reissue of older albums constitutes a growing market potential. Companies have found reissues so lucrative that they have reached back for almost everything—including hundreds of albums that never sold enough to reach the Top 200 sales list. Major labels typically look for titles that can sell at least 10,000 copies, leaving less-popular projects to independents or custom Internet-only divisions which can turn a profit selling as few as 2,000 to 3,000 copies of some titles. The record industry has made its repertoire available: now it must be marketed, promoted, and sold—for download, hire, subscription, wherever and whenever it can. Any music, anywhere, in any form, on any device, for any consumer at any time—just so long as it is properly licensed secure and paid for.

Lifestyle music, or custom music compilation is a growing trend and a new image tool for the retail, products and services business. With its instantaneity feature, the sp-A is the perfect vehicle for a market relying essentially on impulse buying. In the retail store, the sp-A becomes an identity item that associates the purchaser with the retailer's specific universe.

Marketing Brand Music—Target Clients

Several actors are present on the brand music market. They represent the target clients for the digital player of the present invention: Majors' subsidiary labels, marketing their holding company's music catalogue into the brand and sponsoring markets; brands' subsidiary labels; and coffee houses that distributes music CDs through the thousands of company-operated stores in the US as well as novelty distributors, involved in the distribution of brand promotional products. Without production or music licensing expertise, these companies must team up with a label for product development.

Today's hip restaurants, bars, and hotels are breaking into the music business with their own CDs. The Standard Hotel in Los Angeles, Sunset Beach hotel/restaurant in New York's Hamptons, and trendy bars in Paris are just a few cashing in on the “lifestyle music” trend. Retailers have been selling their own compilations at the checkout line for years. Increasingly international brands view music activity and events as a route to exposure and status in attracting target demographics. Sponsorship, accordingly, has moved on a pace. Though the sports industry is ahead of the music industry in some ways, it is clear that sponsorship from a brand's perspective is now about more than a logo on a ticket. By catering exclusively to impulse shoppers, coffee shops created the most successful cross-marketing venture to hit the music business since music television.

The digital player of the present invention with its innovative size and ease of marketing and placement of graphics may be used as a point of purchase gift card with content. Unlike the current gift cards that are simply dead plastic with a bar code, the instant invention may be employed with the bar code as well as storage of digital content thus creating a marketing tool both for music and retailers. The gift card is either sold or given away with an appropriate added amount of gift purchasing power so the giver is not only gifting a gift to purchase other items, but a valuable content based music player. The promotional possibilities are endless and can be used cost effectively by both the content providers of the digital data but by the retailers.

Kids just want to take songs they like and listen to them however they want. As a promotional prize or giveaway, the sp-A is a powerful vector for advertising and mass marketing campaigns. The product is here redesigned to adapt to critical price point: no display, limited memory. From the product manufacturer to the advertising agency, promotion initiatives and mass communication campaigns involve many actors. Furthermore, these campaigns often gather several products, services and partners The offering traditionally originates from the products manufacturers' advertising/communication departments in coordination with record companies. Major retailers have joined or are expected to join food and music labels in using music as a significant branding tool.

While the invention has been described in connection with several preferred embodiments, it is not intended to limit the scope of the invention to the particular form set forth, but on the contrary, it is intended to cover such alternatives, modifications, and equivalents as may be included within the spirit and scope of the invention as defined by the claims.

We claim:

1. A digital storage device comprising:
a. A credit card sized carrier having a memory and processor for processing digital data;
b. An output on said card for converting and transmitting said digital data for audio output;
c. A set of touch sensitive controls on the planar surface of said card;
d. A configurable planar surface for placement of graphics;
e. A USB connector for electrical access to said memory and processor for upload and downloading of said digital content.

2. A digital storage device as claimed in claim 1 further comprising a retractable USB connector that is flush with the carrier when retracted.

3. A digital storage device as claimed in claim 1 wherein the graphics depict the creator of the digital data.

4. A digital storage device as claimed in claim 1 further comprising a video screen.

5. A digital storage device as claimed in claim 1 further comprising touch sensitive controls.

6. A digital storage device as claimed in claim 1 further comprising a bar code.

7. A method of marketing music comprising:
a. Storing digital data content in memory in a credit card sized carrier;
b. Placing graphical information on the flat side of said carrier relating to the creator of said digital data content;
c. Permitting access to said digital data by a user through an interface;
d. Preventing said user from being capable of erasing said digital data from said memory.

8. A method of marketing music as claimed in claim 7 further comprising the step of storing digital data relating to a single creator of said data.

9. A method of marketing music as claimed in claim 7 wherein said digital data is non-erasable from said memory.

10. A method of marketing music as claimed in claim 7 further comprising a USB connector for access to said memory and processor for downloading of said digital content.

11. A method of marketing music as claimed in claim 7 further comprising a volume control.

12. A method of marketing music as claimed in claim 7 further comprising a set of controls to control said digital data output.

13. A method for marketing digital content comprising the steps of:
a. Placing digital content in data memory on a credit card sized handheld carrier capable of outputting said content in an audible and visual format;
b. Compiling content for a particular artist for placement in said memory;
c. Branding the planar surface of said carrier with graphics related to said artist;
d. securing access to said digital content.

14. A method for marketing digital content as claimed in claim 13 further comprising the step of placing video content for display on said carrier.

15. A method for marketing digital content as claimed in claim 13 further comprising the step of placing a bar code on said carrier for encoding the card with redeemable value.

16. A method for marketing digital content as claimed in claim 13 comprising the further step of associating the digital player through internet connection with a website.

17. A method for marketing digital content as claimed in claim 13 further comprising the step of associating the digital content with a promotional campaign of a retailer of goods.

18. A method for marketing digital content as claimed in claim 13 further comprising the step of placing video content in the memory of said carrier.

19. A method for marketing digital content as claimed in claim 13 wherein said digital content is music.

20. A method for marketing digital content as claimed in claim 13 wherein said graphics are placed on both sides of said carrier.
